(19) United States
(12) Patent Application Publication
(10) Pub. No.: US 2017/0046531 A1
(43) Pub. Date: Feb. 16, 2017

(54) DATA ENCRYPTION METHOD AND SYSTEM FOR USE WITH CLOUD STORAGE

(71) Applicant: STRONG BEAR LLC, BELFAST, ME (US)

(72) Inventor: RODNEY B. ROBERTS, BELFAST, ME (US)

(21) Appl. No.: 14/980,131

(22) Filed: Dec. 28, 2015

Related U.S. Application Data
(60) Provisional application No. 62/205,126, filed on Aug. 14, 2015.

(51) Int. Cl. G06F 21/62; G06F 21/60; H04L 9/06; H04L 29/06

(52) U.S. Cl. CPC G06F 21/6218; H04L 63/102; H04L 63/083; G06F 21/602; H04L 9/0631; H04L 63/0428; G06F 2221/2107; H04L 2209/12

(57) ABSTRACT

A system providing cloud storage with enhanced data security. The system includes a cloud storage system with a server storing a cloud data folder with data associated with a data storage user. The system also includes a client device operable to communicate over a digital communications network with the cloud storage system to access the cloud data folder. The system further includes a self-contained encryption unit with an executable encryption program and a data file, and a user of the cloud storage can define which portions of their data is stored in the data file. The encryption unit is provided in the cloud data folder. The encryption program includes an encryption tool that encrypts the data file prior to the data file being stored in memory on the client device or being stored in the cloud data folder in the cloud storage system.

### CROSS-REFERENCE TO RELATED APPLICATIONS

This application claims the benefit of U.S. Provisional Application No. 62/205,126, filed Aug. 14, 2015, which is incorporated herein by reference in its entirety.

### BACKGROUND

1. Field of the Invention

The present invention generally relates to data storage including cloud storage and, more particularly, methods of enhancing security for data stored (and later accessed via multiple client devices/platforms and by diverse users) in a plurality of memory or data storage devices using cloud storage.

2. Relevant Background

With the ready accessibility to the Internet and mobile life style of so many of the world citizens, cloud storage has become increasingly popular for storing data that can later be accessed from many locations and by many differing client device or platforms. Cloud storage is a model of data storage in which the digital data is stored in logical pools, with the physical storage spanning multiple servers that may be in one to many locations. A hosting company (or cloud storage provider) typically owns and manages the physical storage, and the cloud storage provider is responsible for keeping the data available and accessible (e.g., by keeping the physical storage devices protected and running).

People and organizations (or cloud storage users) buy or lease storage capacity from the cloud storage providers to store and access their data via a digital network, which is typically the Internet. While access to the data may be achieved in a variety of ways, a common model is for users to access the cloud storage services or their stored data through a web service application programming interface (API) or by applications that utilize the API such as cloud desktop storage, a cloud storage gateway, or Web-based content management systems.

Cloud storage provides a number of advantages to the data user. The data user only has to pay for the data storage they actually use and do not have to purchase their own data storage devices. Storage maintenance tasks, such as purchasing additional storage capacity, are offloaded to the responsibility of the cloud storage provider. Cloud storage provides users with immediate access to their data and, in some cases, shared data from nearly any location with network access and also to a broad range of resources and applications hosted in the infrastructure of another organization via a web service interface. Cloud storage can be used as a natural disaster-proof backup because there are normally two or more different backup servers for their data that are located in different physical locations around the world.

Unfortunately, there are a number of concerns with the use of cloud storage including issues with maintaining data security. When data distributed at more than one location and in more than one server or other storage device, the risk of unauthorized physical access increases such as when old equipment is disposed of, when drives are reused, and so on. The number of people that can access the data increases dramatically with the use of cloud storage. For example, a single company may have a very small of administrators while a cloud storage provider will have many customers and many servers (e.g., thousands of servers) so that they will require a much larger tem of technical staff with physical and electronic access to the data under their care. The use of cloud storage increases the number of networks over which the data travels when compared with a local area network (LAN) or storage area network (SAN). Also, by sharing storage and networks with other cloud storage customers, it is possible for other customers to access the cloud storage user's data.

More generally, data security is a concern because once data is moved to the cloud the data is out of the user's control. Cloud storage providers may include features for encryption, but the encryption only happens at one of the cloud storage provider's servers and not locally (at the client's device or platform). Most cloud storage providers keep data locally in file systems on the user's client device and, at the same time, in the cloud (e.g., at one or more of the cloud storage provider's servers). The cloud storage provider then periodically synchronizes the locally stored data when the network (e.g., the Internet) is available to the client device. The use of local storage is the reason that cloud storage users are able to edit files when their devices are offline or not connected to the network to which the cloud storage provider's servers are linked. The local files are not encrypted when in the local folders (e.g., the folders that will later get synchronized with data on the cloud storage provider's servers).

In addition to concerns with security of the local files, it is becoming a common occurrence for there to be security breaches that result in lost or stolen data. For example, there are security breaches that allow outside hackers access to credit card data even though there are strict requirements for the storage and encryption of credit card users' account numbers and information. At some point in time, it is very likely that similar data breaches will occur, or already have occurred, for the data stored by cloud storage providers. With current cloud storage provider services and security practices, once a third party is able to logon to a cloud provider, such as with a stolen user identification and password, they are able to access all of the user's data stored on the cloud storage provider's servers.

Hence, there remains a need for methods and/or systems for providing enhanced data security for data stored and access via a cloud storage service. Preferably, these methods and systems would be designed so as to be useful with all or most of the existing cloud storage providers' services without modification of such services or actions by the cloud storage providers (e.g., the new security methods/tools would be adapted for implementation by the user of cloud storage).

### SUMMARY

Briefly, techniques are described for enhancing data security when client devices, such as computers and computing devices (such as tablets and smartphones), are used to store and access data using cloud storage. These data security techniques include use of a single instance of a folder (or Cloud Crypter or CC instance) that stores an encryption program (e.g., a CC executable) and a CC data file. The data file includes files and folders of the user's data that have been identified for increased security. The encryption program includes an encryption tool that uses one or more passwords provided by the user to encrypt (and later decrypt (or unencrypt) for use) these files and folders of the CC data file both when the CC instance is stored on the local memory of the client device (e.g., prior to being synchronized with the user's cloud storage folder). The CC instance remains encrypted when it is stored on the cloud storage system (e.g., in the user's cloud storage folder). The encryption program initiates storing of the CC instance (data file or entire instance) with the underlying storing functions that cause the data to be moved into cloud storage folders being performed, typically, by a cloud storage provider. In this way, the cloud storage data is protected using encryption both while it is on the client device (which may be accessible by the Internet by hackers or may be lost) and while it is being stored on the cloud storage system (which also may be hacked or physically accessed).

More particularly, a system is taught that is useful in providing cloud storage of digital data. The system includes a cloud storage provider system with at least one server storing a cloud data folder with data associated with a data storage user (e.g., a person with access to all the file folders on the client device and the cloud and using the encryption program to secure their data in these file folders). The system also includes a client device operable to communicate over a digital communications network with the cloud storage provider system to access the cloud data folder on the at least one server. The system further includes an encryption unit (or Cloud Crypter (CC) instance) with an executable encryption program and a data file. The encryption unit is provided in the cloud data folder, and the data file of the encryption unit includes a subset of the data associated with the data storage user (which may be arranged in files and/or folders). The executable encryption program includes an encryption tool that functions to encrypt the data file prior to the data file being stored in memory on the client device and prior to the data file being stored in the cloud data folder on the at least one server of the cloud storage provider system.

In some embodiments, the encryption tool comprises a 128 or 256-bit AES (Advanced Encryption Standard) encryption algorithm. In such embodiments, the encryption tool performs the encrypting of the data file using one or more passwords provided by the data storage user via operation of the client device and associated with one or more subsets of the data file. Further, the one or more subsets of the data file are identified by the data storage user by selection of portions of the data in the cloud data folder presently outside the encryption unit or selection of data stored in memory of the client device or memory accessible by the client device.

In the same or other embodiments, after the storage of the data file, the executable encryption program generates a user interface on a display device of the client device prompting entry of an encryption instance password assigned to the executable encryption program (e.g., an “encryption instance” may be the entire CC instance, be the executable encryption program, or be data file). Then, only when a user-provided password is received matching the encryption instance password, the encryption program provides access to the encrypted data file in the cloud data folder.

In these or other cases, after the storage of the data file, the executable encryption program generates a user interface on a display device of the client device first prompting user selection of a portion of the encrypted data file to access, second prompting user entry of a password associated with the portion of the encrypted data file, and, in response to receipt of a user-entered password, using the encryption tool to decrypt the encrypted data file, when the user-entered password matches the password associated with the portion of the encrypted data file, using the user-entered password. In these embodiments, the portion of the encrypted data file is a folder including a plurality of files and/or the portion of the encrypted data file is a single file of data and wherein a different password is assignable by an operator of the client device to each file of data in the encrypted data file.

### BRIEF DESCRIPTION OF THE DRAWINGS

FIG. 1 is a functional block diagram of a cloud storage system (or network) configured for implementing a data security method, initiated and/or controlled by cloud storage users, within a cloud storage service;

FIG. 2 is a flow diagram of a main routine or algorithm implemented by execution of a Cloud Crypter (CC) program in a cloud storage system;

FIGS. 3 and 4 illustrate lock and unlock routines, respectively, performed by the CC program;

FIG. 5 illustrates a settings routine initiated in response to a settings button event during the main routine of FIG. 2;

FIG. 6 illustrates a file menu routine initiated in response to a file menu button event during the main routine of FIG. 2;

FIGS. 7 and 8 illustrate add and get file routines, respectively, that may be called during the main routine of FIG. 2 or by one of this main routine's called subroutines to support the encryption functionalities described herein;

FIG. 9 illustrates in more detail the encryption algorithm provided by running a CC program of the present description including functions/processes performed as part of a plurality of utilities of the CC program;

FIG. 10 is a screen shot of a window or GUI displaying a shared cloud storage provider folder with a CC unit or self-contained module for user-defined cloud storage encryption;

FIG. 11 is a screen shot of a window or CC GUI displaying a data entry box 1110 prompting a CC program user to enter an application initiating password;

FIG. 12 is a screen shot of a window or CC GUI showing presentation of function buttons for selection by a user (e.g., via a mouse event or other user input device operation) including a lock button; and

FIG. 13 is a screen show of a window or CC GUI showing a number of file and folder management operations available to a user of the CC program in a CC unit or self-contained module.

### DETAILED DESCRIPTION

Briefly, the present description is directed toward methods and systems for enhancing data security for users (or customers) of a cloud storage provider. The user (or data storage user) is able to load an encryption management program (which may be labeled “encryption program,” “Cloud Crypter,” or the like herein) into or onto their cloud storage platform (e.g., in their cloud data folder or data set managed by the cloud storage provider). Then, the user can execute the Cloud Crypter when they are accessing the cloud storage services to define which files are to be encrypted and which password/key is to be used for encrypting and decrypting each of these files or folders with a set of files. The Cloud Crypter (or “CC program”) includes an encryption tool (e.g., a 256-bit AES (Advanced Encryption Standard) algorithm or another encryption routine/algorithm) that can be operated by the user to lock (or encrypt) the files with a user-provided or defined password/key or to unlock (or decrypt) files with the same user-provided password/key.

In this way, the cloud storage data may be secured while it is locally stored on the client device prior to synchronization by the cloud storage provider or cloud storage service. Also, the data remains encrypted with the user-defined password/key and the encryption tool on the cloud storage provider's data storage (e.g., server(s) accessible the user), and, since the Cloud Crypter (CC) program is retained in the user's cloud storage folder/platform, the data remains secure and can only be accessed by the user with their password/key (or by someone whom the user has shared the password/key to facilitate secure data sharing via the cloud storage provider).

From reading the following description, it will become clear that one unique feature of the Cloud Crypter (CC) technology is the “unit” or “instance” that pairs the CC executable with the CC data file. The CC Data File can be organized or implemented as a single file or multiple files, but these files are coupled with an executable and are a unit. Also, while the unit is a “logical” pair (executable and data file(s)) such that the executable might be installed in one single location on the computing device versus the directory with the data file(s).

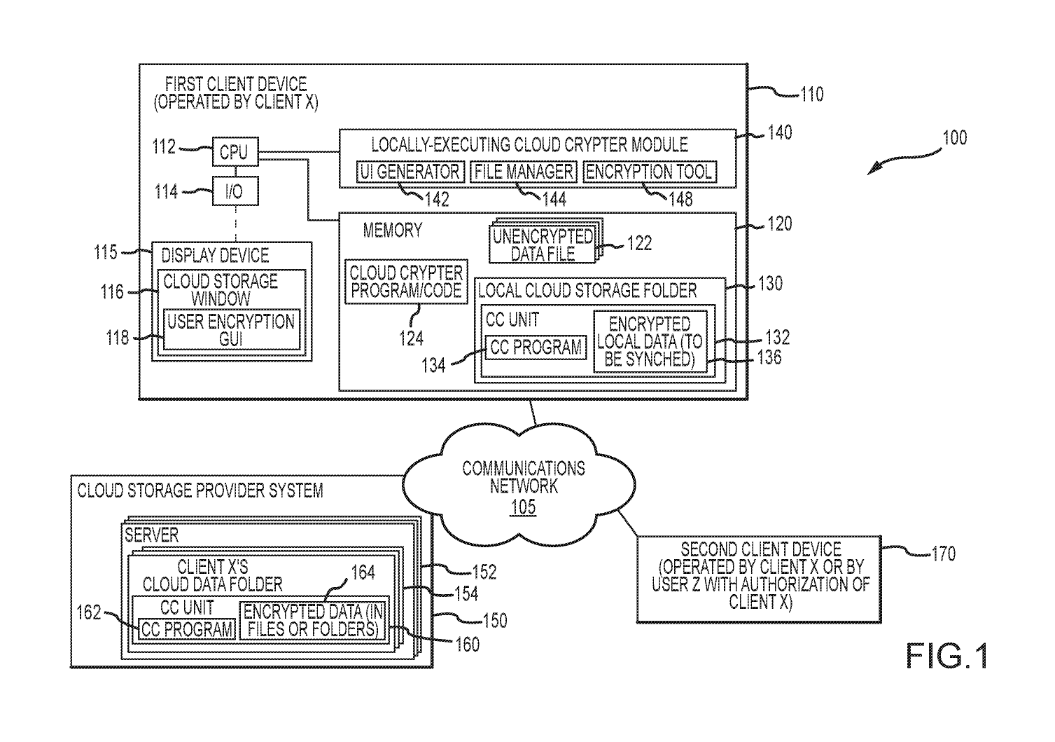

FIG. 1 illustrates an exemplary cloud storage system or network 100 that is configured with enhanced data security according to the present description. In the system 100, client devices 110, 170 are able to communicate with each other and a cloud storage provider system 150 via a digital communications network (e.g., the Internet, which may be accessed in any well-known manner such as via a wide area network (WAN) or the like) 105. The cloud storage provider system 150 is run and managed by a cloud storage provider to provider cloud storage services that include storing their customers' data in data storage as shown with a plurality of servers 152. Particularly, in this example, the server(s) 152 is being used to store data from a first client device 110 as shown with cloud data folder/platform 154 (or Client X′s cloud data folder). This data 154 includes, as is explained in detail below, a Cloud Crypter (CC) unit 160 including a CC program 162 along with user's data 164 that has been organized and encrypted by the CC program (or instance of the CC program) 162 using a password/key provided by the user/operator of the device 110.

The first client device 110 may take a variety of forms to practice the system 100 such as a desk top computer, a laptop computer, a notebook computer, a tablet computer, a smartphone, or other electronic device with necessary computing functions and communications features for transferring data over the digital communications network 105. As shown, the client device 110 includes a processor 112 that manages or controls input/output (I/O) devices 114 to present data to an operator of the device 110 as well as to receive selections and/or user input from the operator of the device 110, and the I/O devices 114 may include a keyboard, a mouse, a touch pad/screen, and the like.

The I/O devices 114 are shown to also include a display device (e.g., a monitor) 115 that operates when the client device 110 accesses the cloud storage provider system 150 via the network 105 to display a cloud storage window or graphical user interface (GUI) 116. This interface/window 116 is typically configured to allow the user/operator of the device 110 to access their cloud storage account to receive cloud storage services including storing and accessing their cloud data 154. Further, a user encryption GUI 118 is shown to be generated and displayed by the processor 112 during operation of the device 110, and this GUI 118 is explained in more detail below as being provided by the locally-executing CC module 140 via its UI generator 142.

The CPU 112 also acts to manage operation of and accessing of memory 120 (e.g., computer-readable media or data storage devices). The memory 120 is shown to store unencrypted data files 122 of the user/operator of the client device 110, and the user/operator may desire to store all or portions of this data 122 in the cloud storage provider system 150 but with enhanced security. To this end, the memory 120 is also used to store (at least temporarily) a copy of the CC program 124, e.g., a set of code or executable instructions adapted to provide the encryption and other functions described herein. During operation of the system 100, the client device 110 is operated by the user to open an interface/window 116 to the cloud storage provide system 150 (and its storage services). This allows the user to access a data folder/platform 154 managed by the cloud storage provider system 150. The user acts to install the CC program as part of a CC unit 160 in their data folder 154 that includes a copy of the CC program 162, and, after synchronizing is completed at a later time, encrypted data 164 (in files and/or folders).

The user can then initiate or select the CC program 162 to run via the cloud storage window 116 to provide data security. This results in the processor 112 executing code to provide the locally-executing Cloud Crypter (CC) module 140 with a UI generator 142 functioning to generate and display the user encryption GUI 118. The CC module 140 includes file manager 144 that assists the user/operator 110 in organizing or managing their data into files and folders that may each include a plurality of folders. The CC module also includes an encryption tool 148 that can be chosen such as with selection of a “lock” button in the user encryption GUI 118 to encrypt data files or such as with the selection of an “unlock” button in the GUI 118 to decrypt previously encrypted files. The encryption tool 148 may be the 256-bit AES algorithm or another encryption program adapted to encrypt data using a password/key input by the user of the client device 110 such as in a prompt provided in the user encryption GUI 118. For example, the encryption tool is functionality that implements one or more encryption (and decryption) functions and algorithms and can be implemented in software or hardware and may take advantage of underlying encryption algorithms that are implemented in software or hardware. An encryption tool, such as the encryption tool 148, can be implemented as a standalone utility called or invoked by a program that performs encryption or an encryption tool can be integrated into a program and called (e.g. via APIs) from and as part of the program performing encryption.

The file manager 144 acts to prompt and/or respond to user input (via I/O devices 144) selecting one or more of the unencrypted data files 122 for encryption by the encryption tool 148. In response, the encryption algorithm 148 acts to encrypt the data using an input password/key, and FIG. 1 shows that a local cloud storage folder 130 is stored in memory 120 including a copy of a CC unit 132 that includes the CC program 134 and the encrypted data 136, which is yet to be synchronized by the cloud storage provider system 150 or its cloud storage services. In this manner, local cloud storage data is retained on the client device in a secure manner. Once synchronization is complete, the client's cloud storage data 154 is stored on one or more servers 152 in the cloud storage provider system 150, and the data 154 includes a CC unit 160 with a copy of the CC program 162 along with the data 164 encrypted on the client device 110 by the CC module 140.

During operations of the system 100, after the user has created the CC unit 160 in their cloud data folder 154, the next time the user operates the client device 110 to access the cloud storage provider system 150 they are able to initiate the CC program 162 to again have the locally-executing CC module 140 be provided by the processor 112. This causes the user encryption GUI 118 to be generated and displayed in the display device 115, and the user can select which of its files and folders in the encrypted data 164 to access and unlock with the encryption tool 148 and an entered password/key.

Likewise, the system 100 is shown to include a second client device 170 that can communicate with the cloud storage provider system 150. The user/operator of client device 110 may use this other device 170 (which may include the components 112-140 shown in first client device 110 or a subset thereof to provide the functionality discussed herein), which may be in the same or a different geographic or physical location (e.g., the user/operator may be traveling and use a different client device to access their cloud-stored data), to access their cloud data 154. Since the CC unit 160 is part of this data 154, the user can enter activate the CC program 162 and use the same password/key to have the CC program 162 decrypt the data 164 or to encrypt additional data on the second client device 170 for secure local storage and later synchronization by the provider system 150 to be part of the encrypted data 164. Alternatively, the user/operator of the client device 110 may share the password/key for encrypted data 164 with another user that can then use this password/key to access the encrypted data 164 (e.g., to view it, to modify it, and/or to add to it) with security provided again by the CC program 162, which would be executed locally on the second client device 170.

From the description of FIG. 1 and its cloud storage system 100, it can be seen the inventor is describing a method (and corresponding computer systems) that is useful in providing data encryption and other services to users of cloud storage. The method and software may both be labeled “Cloud Crypter,” which can, in practice, be provided as a stand-alone software program (or the “CC program” or module) that is designed to be used within existing cloud technology platforms providing the user with maximum mobile security for their data. The CC program may include an encryption tool that uses the 256-bit AES algorithm or another useful encryption algorithm to perform the encryption process. With the encryption tool, the CC program encrypts and decrypts individual files and/or folders of files with a single or with different passwords that the user of the CC program may assign or define depending on the level of security they require or desire for their data being stored using cloud technology.

As shown in FIG. 1, in some useful embodiments or implementations, the CC software or program is installed into the user's preselected cloud storage platform where it is adapted to reside as a self-contained unit (e.g., FIG. 1 shows a separate CC unit containing the CC program but these may be thought of as a single unit in some cases). When the CC unit's (or the CC program's) interface is accessed by the user through the cloud storage access window or interface, the user is prompted to type in a password (e.g., a password of a plurality of digits such as, but not limited to, eight or more digits).

If accepted as correct by the CC unit/program, the user can then drag and drop (or otherwise move/copy) a number of user-specified files from their local memory (or memory accessible by their presently-used client device) onto the CC program's GUI or UI. The user then can indicate to the CC program, such as by pressing a “Lock” button in its GUI, that encryption is desired for these files, and the CC program uses its encryption tool to encrypt the files, which the CC program then stores within the CC unit on the cloud storage platform (which, in most cloud technologies is temporarily performed locally until synchronization operations are performed (e.g., periodically when network (e.g., Internet) access is available for the client device).

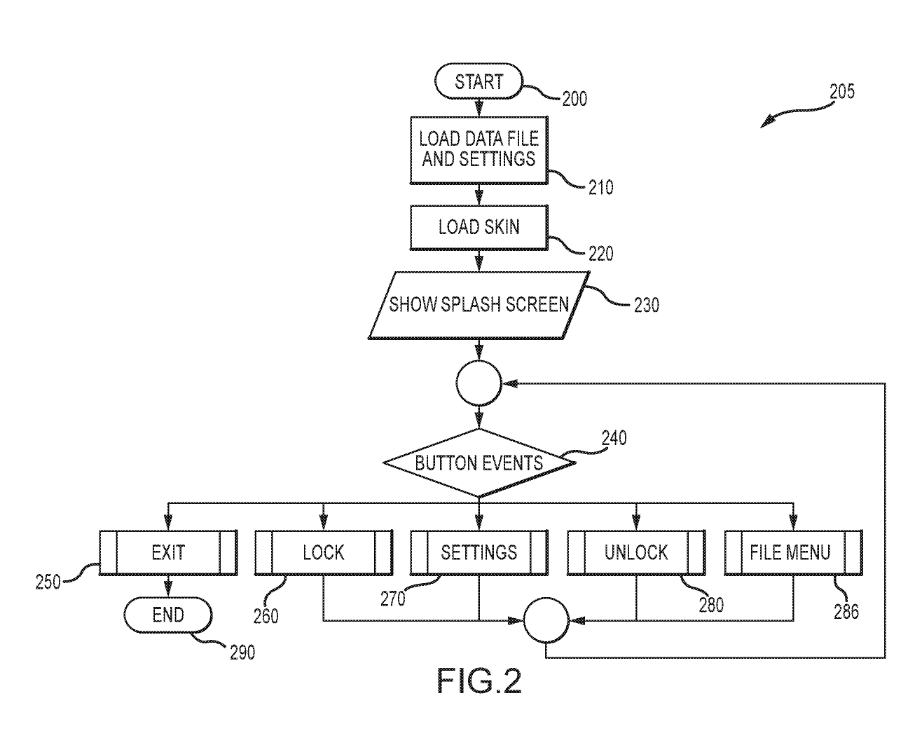

FIG. 2 illustrates a main routine or functional flow of the CC method 200 as may be performed by the CC program of FIG. 1. The method 200 starts at 205 such as with a user of the cloud storage loading the CC program into their cloud storage platform and initiating the CC program during a cloud storage session. In step 210, the CC program acts to load the data file (e.g., from local memory if working offline or from one of the cloud storage provider's servers) and its associated settings (e.g., file and folder organizations, GUI settings/parameters, CC program password, and so on). At step 220, the CC program acts such as via its UI generator to load a skin and other portions of the user interface, and, at step 230, the UI is generated and displayed in a monitor or display device of the user's client device. At step 240, the CC program monitors for a button event (or a user input event causing a functional selection for the CC program). When a button event is detected at 240, the method 200 continues by performing the function corresponding to the button such as exiting 250 and then ending the routine 290, locking files of the loaded data set at 260, showing and allowing adjustment of settings at 270, unlocking files of the loaded data set at 280, and showing a menu of the files in the loaded data set at 286. The method 200 may then continue at 240 with monitoring for a next button event.

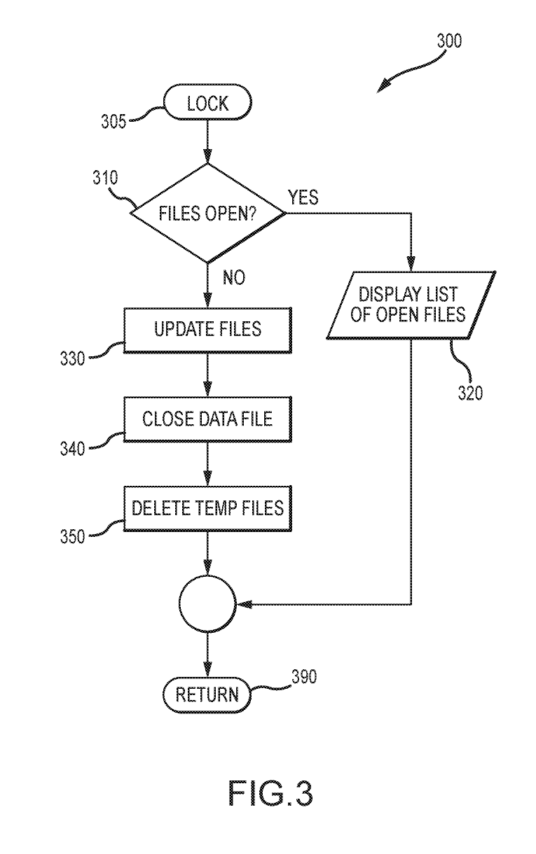

FIG. 3 illustrates a lock method 300 that may be performed upon the occurrence of lock button event as shown at 260 in FIG. 2. At step 305, the lock routine is called by the main CC program routine, and, at step 310, the lock routine or algorithm 300 involves determining if files in the data set are open. If yes, step 320 includes displaying a list of all open files to the user in the CC program's GUI and then returning to the main routine at 390. If no, the method 300 continues at 330 with updating files, which includes encrypting the chosen files using the encryption tool and the user-provided password. Then, at 340, the data files are closed as needed, and, at 350, any temporary files are deleted prior to returning to the main routine at 390.

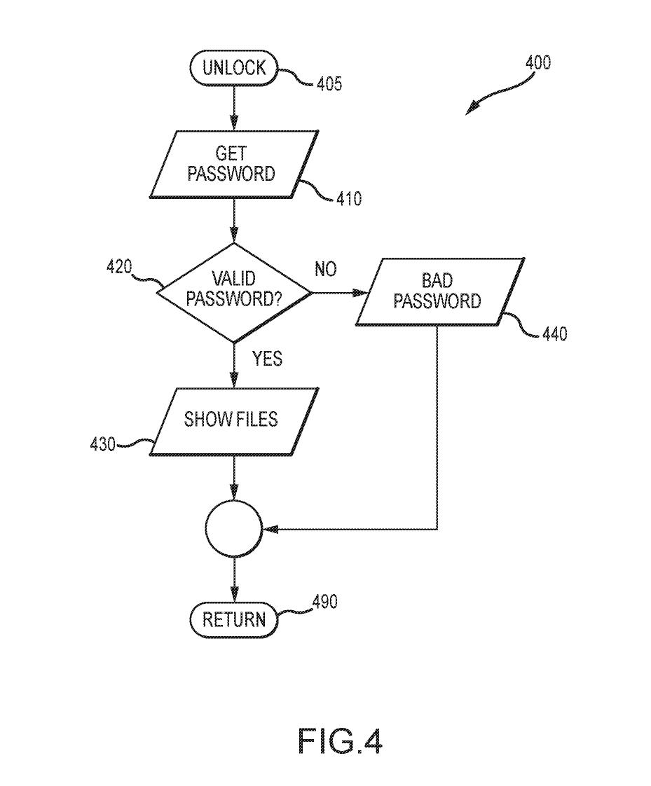

FIG. 4 illustrates an unlock method 400 that may be performed upon the occurrence of an unlock button event as shown at 280 in FIG. 2. At step 405, the unlock routine is called by the main CC program routine, and, at step 410, the unlock routine or algorithm 400 involves obtaining the password from the user of the client device such as via the CC program's GUI in the client device. At 420, the method 400 involves a determination of whether the password is valid. If not, the method 400 involves at 440 updating the GUI to inform the user of the client device that the password is bad or improper. If the password is determined to be valid at 420, the files are decrypted by the encryption program using the valid password and at 430 the decrypted files are provided to the requesting user. The method 400 may then return at 490 to the main routine of the CC program.

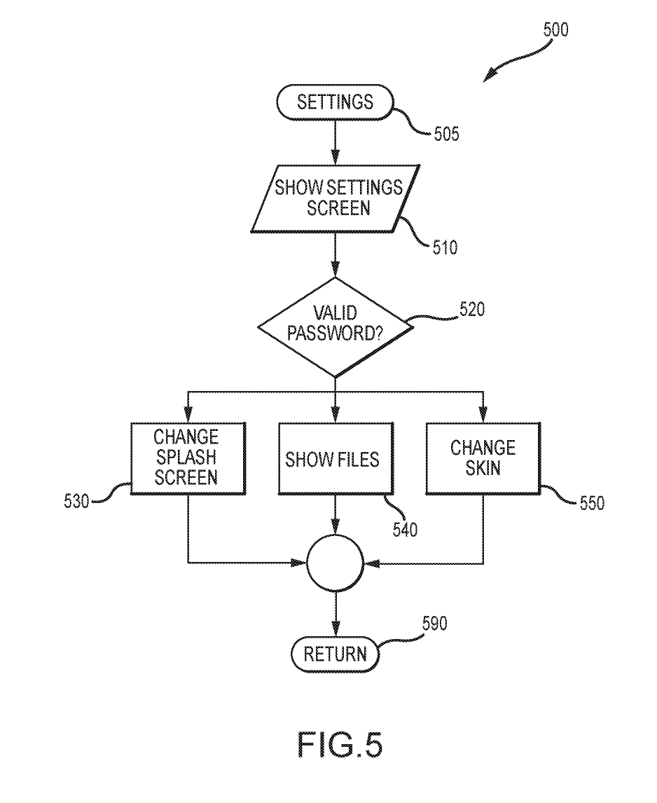

FIG. 5 illustrates a settings method 500 that may be performed upon the occurrence of a settings button event as shown at 270 in FIG. 2. At step 505, the settings routine 500 is called by the main CC program routine, and, at 510, the GUI is updated to show the settings screen that allows the user to modify one of a number of CC program settings (e.g., splash screen, password, skin, and so on). At 520, the method 500 monitors for a menu choice by the user via operation of the user input device(s) of their client device. When user input is detected indicating a menu choice at 520, the method 500 continues as appropriate (based on a user change selection) with changing the splash screen 530, changing the password (e.g., to the main CC program) 540, or changing the skin 550. The method 500 then acts at 590 to return to the main CC program.

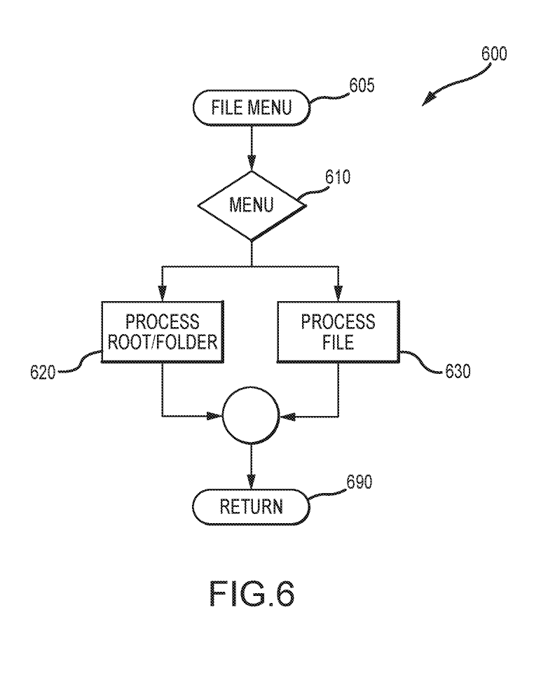

FIG. 6 illustrates a file menu method 600 that may be performed upon the occurrence of a file menu button event as shown at 286 in FIG. 2. At step 605, the file menu routine 600 is called by the main CC program routine, and, at 610, the method 600 proceeds which menu action is chosen by a user via the displayed GUI and operation of a user input device (e.g., a mouse event or the like). The method 600 may continue at 620 with processing the root or folder or at 630 with processing a file, and then at 690 the method 600 returns control to the main CC program.

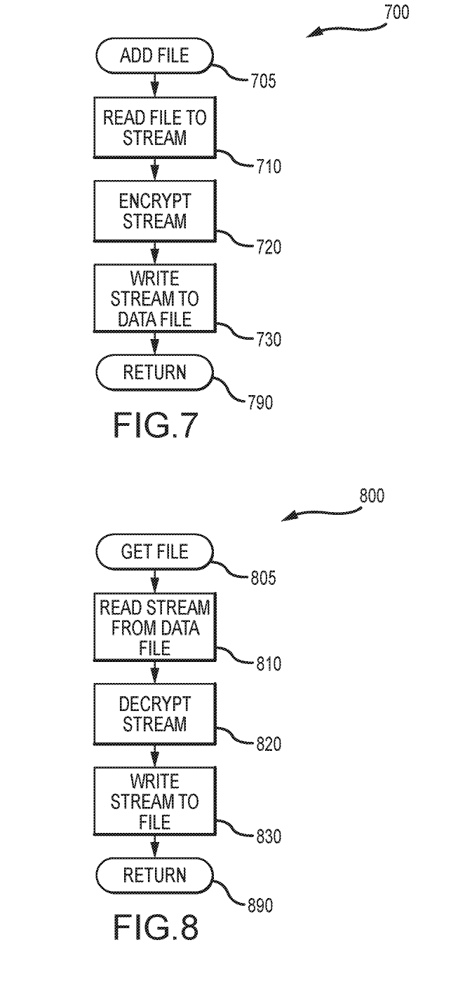

FIGS. 7 and 8 illustrate add and get file routines 700 and 800, respectively, that may be called by the main CC program or one of its subroutines as shown at steps 705 and 805. As shown in FIG. 7, the method 700 continues with step 710 by reading a next (or user-selected) file to a stream. Then, at 720, the encryption tool is used to encrypt the stream, and, at 730, the encrypted stream is written to the data file of the CC unit. Control is returned at 790 to the calling routine/subroutine. As shown in FIG. 8, the method 800 continues with step 810 of reading a stream from the data file in the CC unit. At 820, the stream is decrypted by the encryption tool using a valid user-provided password. Then, at 830, the decrypted stream is written to a file that may be accessed by the user via the GUI. The control is then returned at 890 to the calling routine/subroutine.

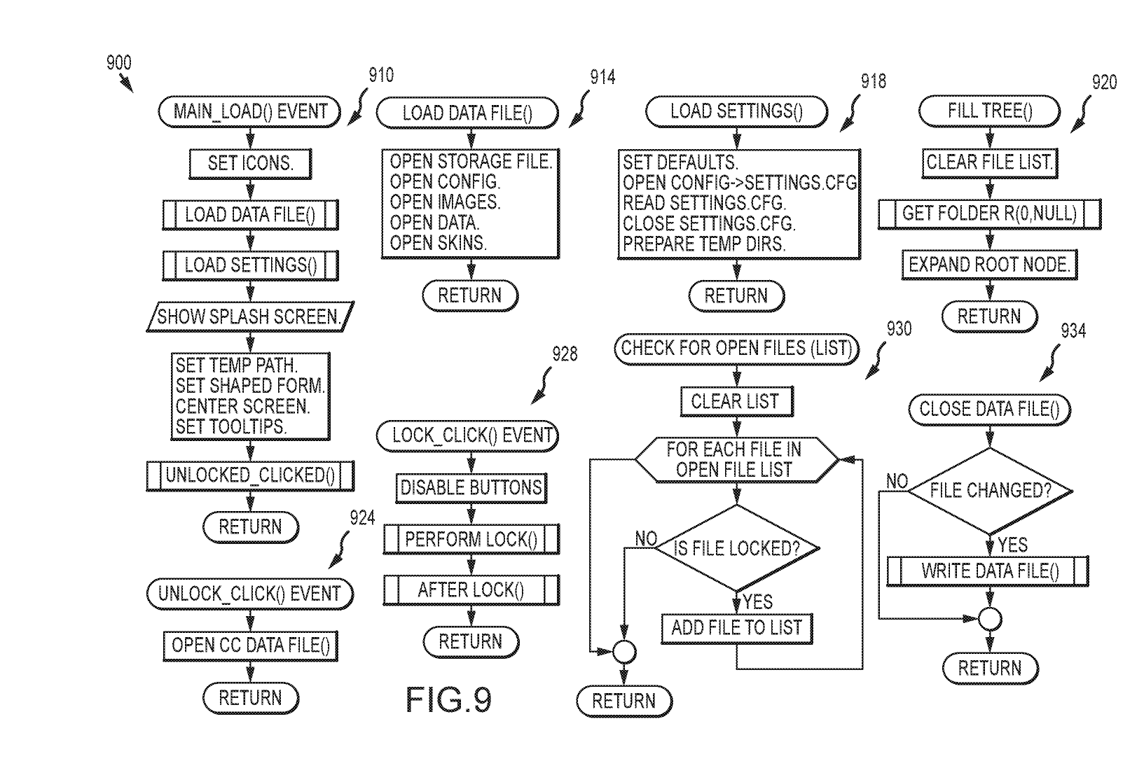

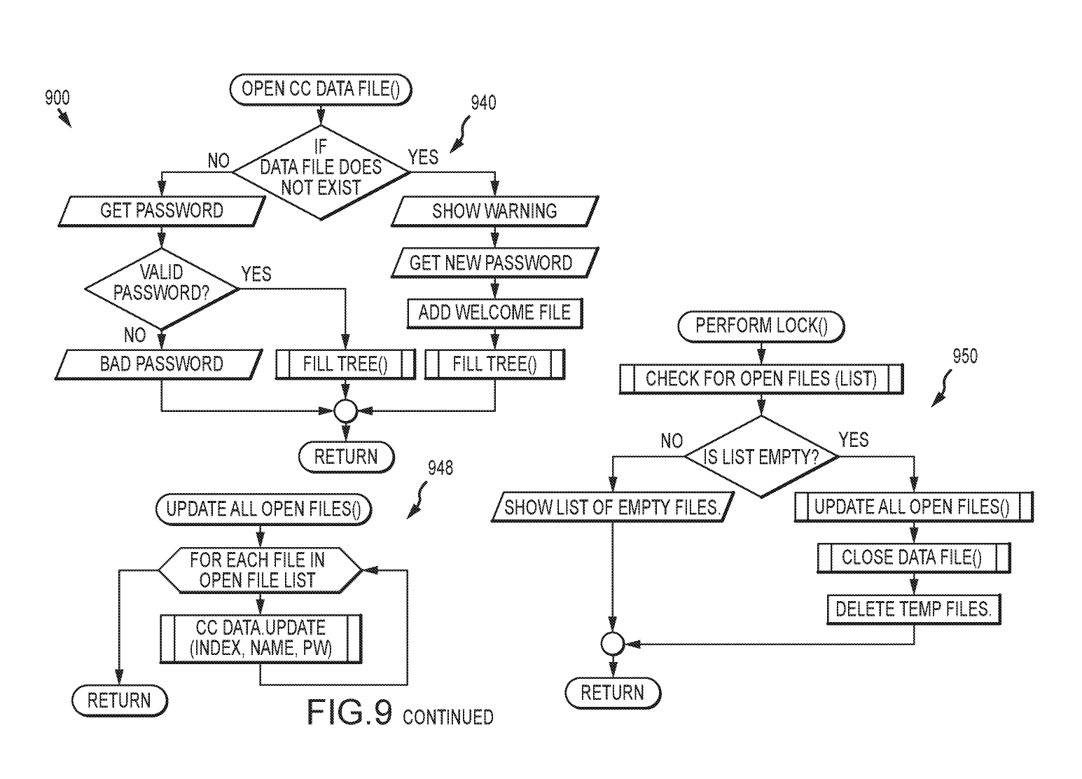

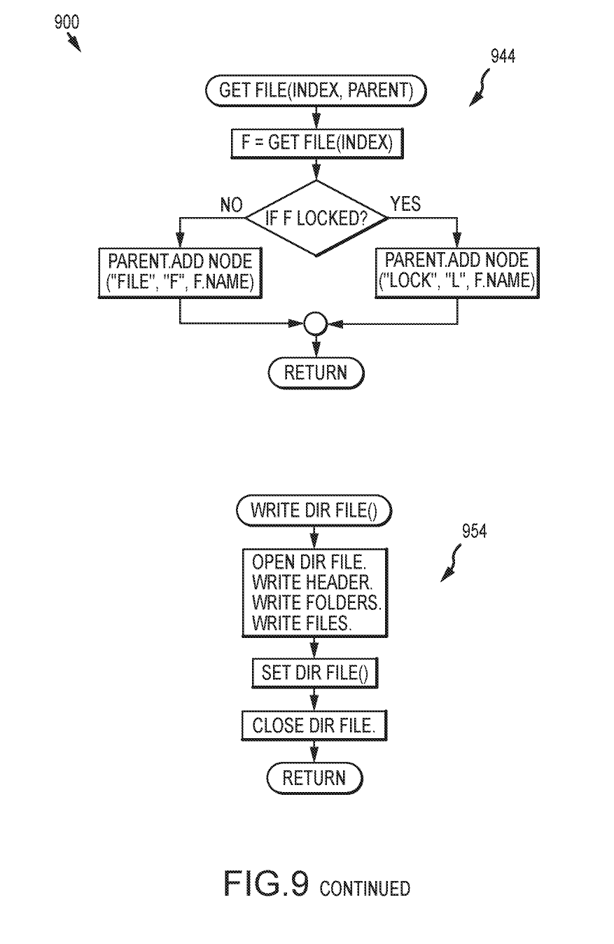

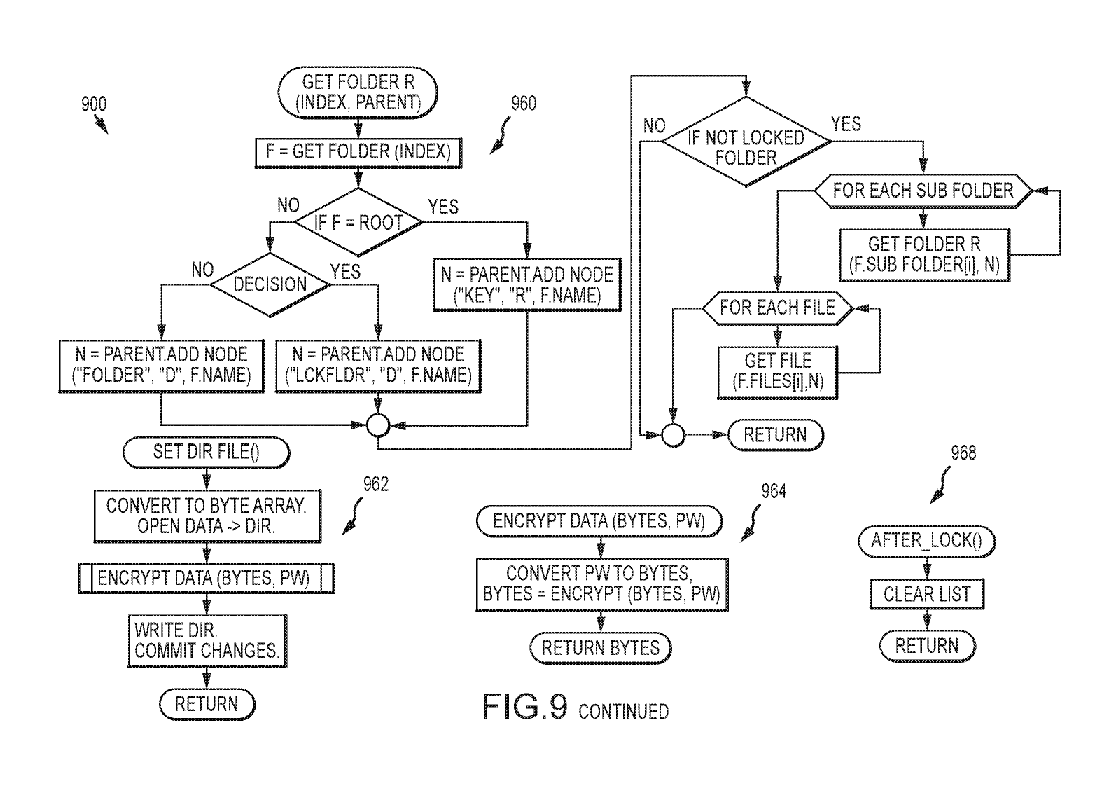

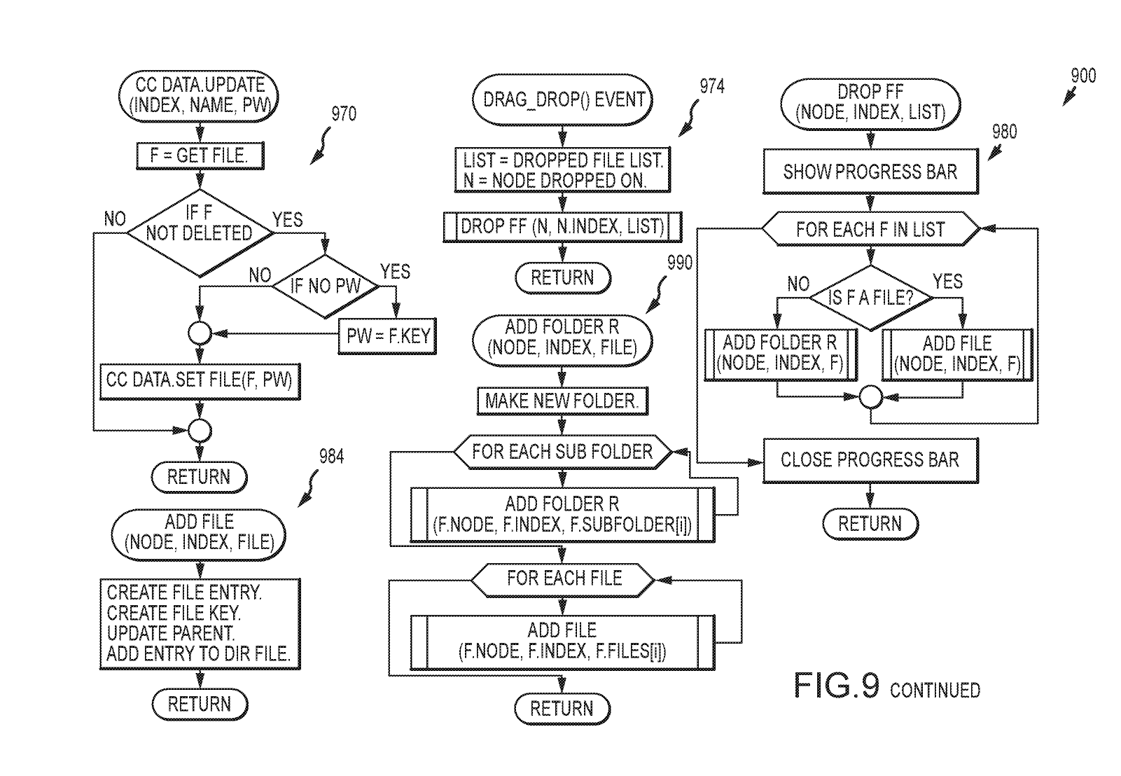

FIG. 9 shows a set of utility routines that may be combined to provide a CC method 900 of the present description. These routines includes functions/steps that combined with the box labeling and flow of the diagrams provides adequate detail for implementation of the CC method 900 by one skilled in the computer and/or software programming arts. Particularly, the CC method 900 is shown to include or call the following routines or utilities: a main load event routine 910, a load data file routine 914, a load settings routine 918, a fill tree routine 920, an unlock click even 924, a lock click event 928, a check for open files routine 930, a close data file routine 934, an open CC unit's data files routine 940, a get files routine 944, an update all open files routine 948, a perform lock routine 950, a write directory files routine 954, a get folders routine 960, a set directory file routine 962, an encrypt data routine 964 (which may be performed by the encryption tool by converting the password to bytes for use as a key with the 256-bit AES algorithm or other process), an after lock routine 968, a CC data update routine 970, a drag and drop event routine 974, a drop folder or file routine 980, an add file routine 984, and an add folder routine 990. All or portions of these functions/routines are described further below with reference to corresponding screen shots that may be provided in the CC program's GUI on the client device's monitor, with the GUI being useful for allowing a user to interact with their data and provide user input to configure operations of the CC program.

As can be seen with reference to FIGS. 1-9, the Cloud Crypter solution (method, software, and systems implementing such software/functionality) encrypts the files in the cloud storage provider folder. This means that the only way to gain access to the files locally on the client device or platform (such as when a computer is not connected to the Internet or when the files are edited and have not yet been synchronized to the cloud) is by providing the correct password to the CC program. Without the proper password, the files are encrypted and can only be access by the user of the cloud storage or a user with the password. When the files are stored (or synched via the cloud storage technology/services) by the cloud storage provider, they remain encrypted via the CC program. Hence, in the case there is a breach of cloud storage provider's system or storage devices, the files stored by the CC program are encrypted using a password assigned by the user associated with those cloud-stored files. This makes it very difficult for the files to be opened and read by anyone other than the owner of the files or another user given permission/granted access by this owner of the files.

If there is a breach and unknown third party tries to read a CC program-stored file, they will face multiple problems. First, initiating or opening the CC program (and/or a CC unit on the cloud storage provider's system or a local client) requires authentication with a unique password (which may be known/assigned by the cloud storage provider or independently in some cases). Note, some cloud storage providers require a user ID and password from a user before allowing access to the user's folders and files (stored by the cloud storage provider), and the CC program password for opening this program typically will involve a separate, additional step. Second, to access files in the CC unit or once the program is open, the user will have to provide one or more additional passwords depending on how the users have decided to secure the files/folders. The CC program typically allows the user to store files and folders (in, for example, a CC unit) using the same or different/unique passwords (which can be useful for multi-user access to a CC unit in cloud storage so that individual users can keep some data private while others files or folders are shared with more than one user knowing the CC password(s)). Third, the underlying data file used by the CC program is not a known file format/type so that someone would need to understand the structure of the file in order to read the data in the file. Fourth, the encryption algorithm is chosen to be very difficult to defeat without knowledge of both the password and the specific encryption algorithm being utilized by the particular CC program instance (e.g., the 256-bit AES algorithm may be used by some CC units while others may use a different encryption process).

The CC program is designed to support a wide variety of client or computing devices. Users of the CC programs are able to access CC files regardless of the computing devices they use to take advantage of cloud storage. In today's world, users often have more than one computing device, and they want the ability to access data stored on cloud storage platforms using any and all of these computing devices. For example, a user may have a computer such as a laptop, a personal computer (running Microsoft Windows or the like), a personal computing device (running an Apple OS), a smart television, cable and satellite television boxes, streaming media devices, and so on while also having a mobile phone and a tablet, and they want to access and store media files (e.g., digital photos, videos, music, and the like), documents, e-books, and other data from all of these devices from the same or varying geographic locations. The CC program can operate on multiple devices to allow users of those devices to access CC data stored in the cloud storage provider platform (or on their storage devices using their storage technologies/services). It should be understood, too, that the CC program can operate across multiple cloud platforms, and, in this regard, the CC program may support adding of files to and from different cloud platforms (e.g., a user can add files from a Google Drive folder into a CC unit stored in a Dropbox folder).

With regard to personal cloud and media storage, an example of a personal cloud and media storage device is a storage device that is attached to an in-home router/wireless router. The device (which may be used to implement the provider system 150 in the system 100 of FIG. 1) provides wired/wireless storage capability for all devices (e.g., devices 110 and 170 in FIG. 1) that are able to access the router. These storage devices are typically for use in the home and for access and storage by in-home computing devices such as laptops, tablets, and smartphones. The storage devices may have terabytes of storage and are used to store all types of data including content such as photos, videos, music, documents, and the like. They can also be used as backup storage for the computing devices of the home users, which are typically connected to an in-home, wireless router or an in-home network that is also connected to the Internet (or an outside digital communications network). Thus, the information stored on these storage devices can be accessible via the Internet and is, therefore, at risk of being hacked. Some of the personal cloud and media storage products provide the ability for users to remotely access files via user IDs, passwords, and/or other credentials.

These personal cloud and media storage devices present opportunities for hackers to access data that without the present teaching may not be protected. Storage for backed up computers or copies of files from these computers may make all sorts of data, which previously would not be encrypted, available for a hacker. Use of a CC program to encrypt files stored on these devices can be used to effectively protect the data. Files are stored in a CC unit and, therefore, are not singly identifiable or readable. The files are encrypted and can only be access via passwords. These personal cloud and media storage devices may be considered to be included within the broadly construed term “cloud storage.” Further, any device that stores data and that is accessible via an external network or the Internet is a candidate for use of the CC program, and these network-accessible devices can be considered to provide or be part of cloud storage (as they are linked to the cloud).

With regard to collaboration, many cloud storage platforms allow folders (or files) to be shared by multiple users. Once a user has access to a shared folder (such as a cloud storage provider folder), they are able to see everything in that folder and in sub-folders. This is also true when the CC technology described herein is used. However, the CC program provides a secure environment, because files and folders it stores are encrypted for users to work on (edit/update/create) and share. Any user with access to a cloud storage platform folder can access and/or open the CC unit and its CC program instance but to access the data stored in the CC unit they need to have the correct passwords. For example, one or more people working on a project can use the CC program to stored project related files and documents. Because the CC program supports encryption for individual files and folders, it enables users to decide which files and folders they want others in the collaboration group to be able to open and view. If users want files to be shared with other users, they either do not assign passwords (and do not encrypt the files) or they share the passwords with other users. If users do not want other users to see files or content in the files, they can assign a password, use CC to encrypt and lock them, and keep the password secret (or only shared on a limited basis).

Cloud Crypter is a service (e.g., a software program or application) that has been designed to be used with cloud storage platforms providing the user with maximum security for their data. The program uses an encryption algorithm or tool (such as the 256-bit AES algorithm or the like) to provide effective data encryption building on a user-input password. The CC program encrypts/decrypts individual files and/or folders, and they can have separate passwords assigned to suit the level of security desired by the user (and users can decide in the CC program whether to assign separate passwords). This means that every file, picture, folder, and other cloud-stored data can have its own unique password, which allows the user to easily and securely collaborate with colleagues worldwide while providing secure data and packets simply by giving their colleagues certain passwords to specific folders within the CC unit or self-contained module available via the cloud storage provider's system.

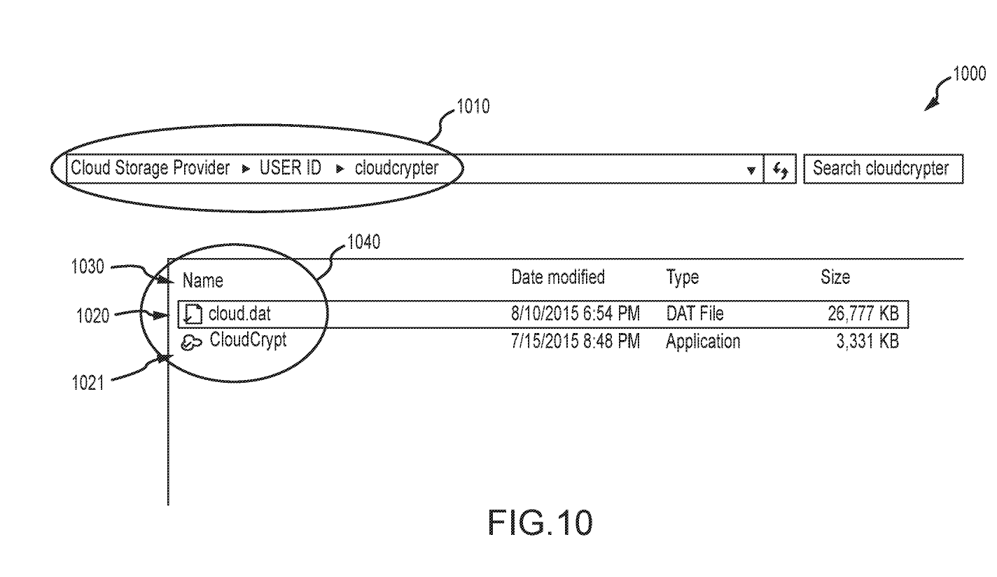

In practice, the CC program or software (e.g., any type of executable file) is installed (e.g. placed, copied, and located) in a cloud storage platform folder. FIG. 10 provides a screen shot 1000 of a window or GUI (e.g., a Windows Explorer window) displaying a shared cloud storage provider folder 1010 named “CloudCrypter.” In this folder 1010, the file “CloudCrypt” 1020 along with the “cloud.dat” file 1030 make up an exemplary CC unit or self-contained module 1040 that is placed by user in a cloud storage platform folder so as to implement the cloud storage data encryption functions described herein. Note, this CC unit or self-contained module 1040 may be placed and used in more than one folder on the cloud storage provider's system/platform.

The CC program can operate on multiple cloud storage platforms, with some presently available platforms including Microsoft Cloud, Dropbox, Google Drive, and Apple Cloud, where the CC program resides in a self-contained module or CC unit. If a user has more than one cloud platform installed on or in use on a computing device (or client device), the CC program may be used with all or a subset of these platforms on the same computing device. Also, the CC program may operate on virtual machines (e.g., VMware machines or the like) where it would be placed and reside in a directory or folder on the machines as a self-contained module or, in some cases, be pre-installed in directories in virtual machine instances. Also, as discussed above, the CC program can operate on personal cloud storage devices such as products including Western Digital's My Cloud, Toshiba's Canvio Personal Cloud, and Seagate's Personal Cloud.

In use, each instance of a CC program (e.g., CC software that is executable within a cloud storage folder) acts as an archive/vault/locker that has files and folders (of files) added into it. Files and folders that are added are encrypted and stored by the CC program. Interestingly, added files and folders are placed in the CC unit or self-contained module and are not simply stored as individual files/folders in the user's cloud storage folder. In this way, anyone looking at (or inspecting) a user's cloud storage folder with a CC unit or self-contained module only sees the CC executable and data file (e.g., .exe and .dat files in the CC unit), and they will have no idea of the files or folders held in the CC unit or self-contained module in the user's cloud storage folder. Files added to the CC unit or self-contained module may remain in the original location in unencrypted form and, in these cases, are not removed from the original location. Files added to the CC unit or self-contained module can come from other folders/files on the local computing system or can be ones stored in cloud storage.

When the self-contained module's CC program interface icon is accessed (e.g., icon 1021 shown in interface 1000 in FIG. 10), the cloud encryption environment provided by the CC program opens (e.g., the CC program executes on the client device to generate and display the CC GUI on the device's monitor screen). Additionally, the cloud encryption environment may be opened when a user clicks the executable in a cloud storage provider folder or may be opened by other methods that may be used to start a software application on the computing device being used to access cloud storage (e.g., this may be starting or invoking an executable (.exe file) on a Windows Platform but it may also be via a URL, via a command file, or via another form or type of launcher application/service that would cause the CC program to run and open.

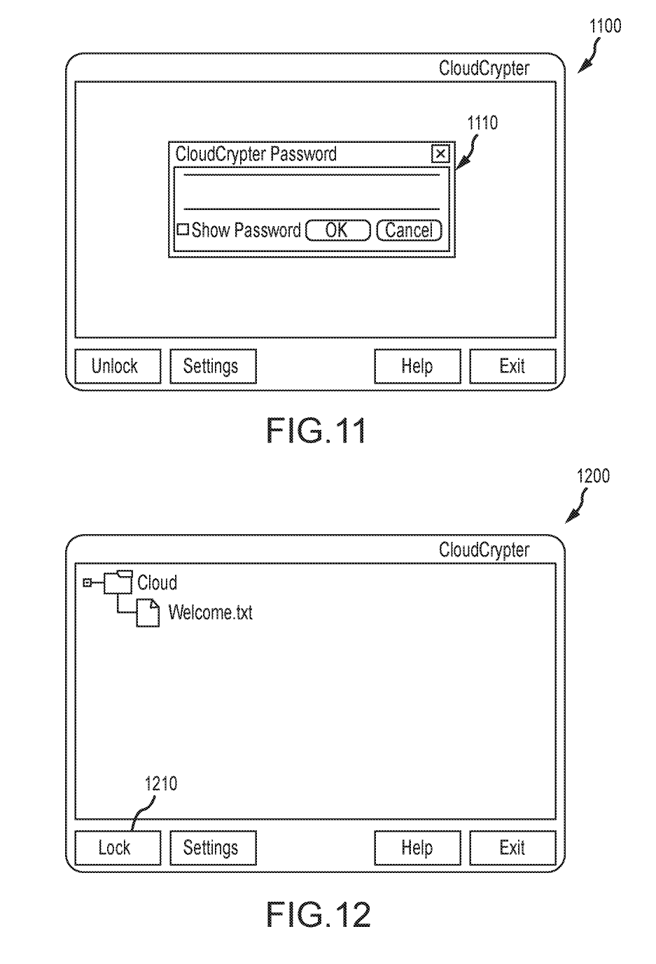

FIG. 11 illustrates a screen shot 1100 of a CC GUI that may be displayed by operation of a client device to prompt a user in a data entry box 1110 to enter a password to be able to use the CC program and access data within the CC unit or self-contained module. The user, for example, may be required to enter a password of eight or more digits, the CC program may access memory to determine if this is a valid CC program activation password, and, if valid, the CC program or application may open up for full usage by the user of the particular client device.

The first time the CC program is started an initial screen may be provided in the CC GUI allowing a user to establish a password for the CC program. This password is then the one assigned to this particular instance of the CC program or application. Anyone attempting to open or access the CC unit or self-contained module will be prompted (such as shown in FIG. 11) for this particular CC program initiating password. Hence, in operation of cloud storage system, the only way one can gain access to the CC unit by knowing the password (e.g., be the person who initially defined the password or be told the password by the person who created or installed the CC program instance). In this description, this password may be referred to as the CC instance password or CC program initiation password to distinguish it from the passwords used by the CC program to encrypt files and folders with its encryption tool or algorithm. The CC instance password is the password that is required when the user clicks on the CC program icon (e.g., icon 1021 in FIG. 10) or clicks on or otherwise invokes the CC program in the user's cloud storage folder.

During use of a CC program, the user can add files and/or folders to the CC unit or self-contained module from their local memory or from other portions of the cloud storage folder. For example, the user may operate the client device's user input device to add files and/or folders can be added by dragging and dropping select ones of the files and folders onto the CC program GUI (or an add box or portion of such a GUI). The files and folders can also be added by clicking (or otherwise selecting) on the folders (and, for example, obtaining a right click menu via a mouse event with an add file option) in a file list displayed by the CC program (or by the cloud storage service) in the CC program GUI. Note, some operating systems/platforms and data storage applications may manipulate data in different ways and/or use terms other than “file” or “folder,” but the CC technology described herein for encrypting a subset of the cloud-stored data would be applicable to these operating systems/platforms and data storage applications (e.g., the term “file” and “folder” is intended to be construed broadly so as to cover elements or components of data storage having similar definitions/functionality but with differing labels).

FIG. 12 illustrates another screen shot 1200 of the CC program GUI at a later operating state than shown in FIGS. 10 and 11. As shown, the GUI 1200 includes a showing of folders (and files in such folders) that are presently in the CC program screen or self-contained module. When the user selects or presses (such as via a mouse positioning and clicking) a lock button 1210, the CC program detects the lock button selection by the user and, in response, activates or calls the encryption tool. For example, a 256-bit AES encryption process may be activated, and the files (or folders) are then encrypted using a single user-provided password or two or more passwords assigned to sets of the files or sets of the folders. The encrypted files are then stored by the CC program within the self-contained module or CC unit. All work can be (and typically should be for security reasons) performed within the CC environment so that no sensitive data remains unencrypted and available for data theft/hacking in a general “public” area of the cloud storage system or a user's shared CC folder. Then, this stored, encrypted data can be retrieved from any computer with access to that particular cloud storage provider's system along with possession of the one or more passwords assigned to the files and/or folders.

Further, with regard to working with data (or files) in a CC unit, files can be accessed and opened by initiating the CC program with the CC program instance or initiating password and selecting the unlock button with correct encrypt/decrypt passwords. The user can then access/read/view the content and, in some cases, edit the data/content of the opened files. The user may then again select lock in the CC program GUI and, if needed, enter the passwords to encrypt the files and store them into the CC unit or self-contained module.

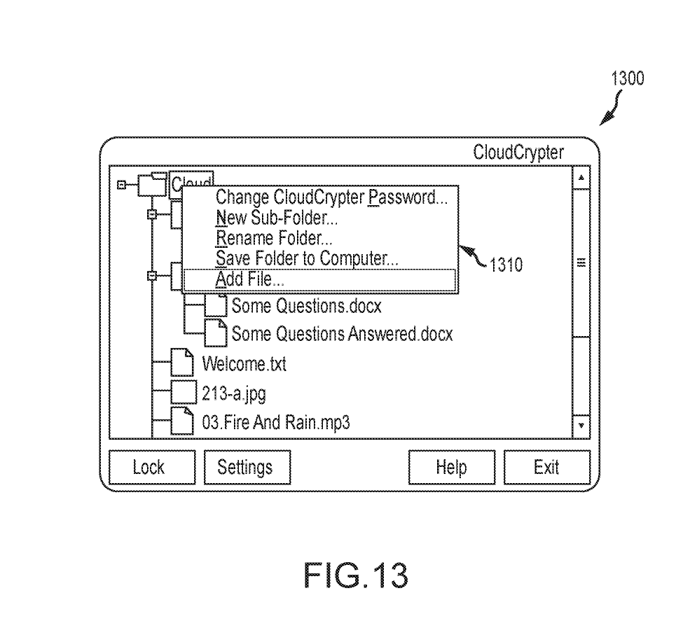

FIG. 13 shows another screen shot of the CC program GUI 1300 at an operating state of the CC program where a user has provided input to cause an action/function dropdown or selection box 1310 to be displayed. From this GUI 1300 the user may change their CC program instance or initiation password, may add a new sub-folder, may rename a folder, may save a folder, and may add files to the CC unit. With regard to new sub-folders, the user can create folders and sub-folders within the CC unit (e.g., within or as part of the CC data file shown at 1030 in FIG. 10). The folder structure provided and managed by the CC program does not need to have the same folder structure/hierarchy or have the same folder names as the original locations.

Through GUI 1300, the user may also choose to add files, from another location in memory that is on the computer or accessible by the computer, into the CC unit or self-contained unit. The GUI 1300 also allows the user to choose to rename one or more of the CC folders. Further, the user may choose to save folders to the computer. The CC program allows the user to save folders, sub-folders, and files in those folders in a CC unit into a specified location on the computer, and, in some implementations, only the unencrypted files and folders the CC unit are stored. In some other implementations, different options may be provided such as prompting the user for encrypted files and folders to obtain an indication if the file or folder is to be stored on the computer and, in such cases, prompting for a password to unencrypt and save the file or folder contents to the computer's memory (or memory accessible by the client device).

From the GUI 1300 or another state of the CC program GUI, the user can select an “add folder password,” which causes the CC program to respond by updating the GUI to prompt the user to provide a password to be provided for a selected (e.g., via a mouse click or the like) folder. This password is then used to encrypt the folder by the CC program and its encryption tool. The user may select an “add file password” function in the GUI 1300 or another state of the CC program GUI, and the CC program may act to update the GUI to prompt the user for a password to be provided for a selected (via a mouse or the like) file. The password is then used to encrypt the folder by the CC program and its encryption tool. In this manner, the user is able to define passwords specific to each folder and file in the CC unit (although like passwords may be used for one or more files and one or more folders (e.g., same password for all data used by a collaborating group of users of data in cloud storage) in encrypted or in unencrypted form. When in encrypted form, the password would typically be the same one defined when stored in the CC unit.

In this description, “Cloud Crypter instance” or “CC instance” or “CC unit” or “self-contained module” may all be used to refer to a file folder that stores the CC program or application executable and .dat file. A user can have one or more CC instances, and any cloud storage folder that holds a CC program executable and a .dat file is a CC instance. Users can have as many CC instances as they want on one or more cloud storage provider systems. With regard to usability, each of use and additional features for the CC program and method include working with, managing, and manipulating one or more CC instances. It is not assumed that a user will have only a single CC instance. There are many reasons that users may want to create more than one instance such as based on a project, based on a function, and so as to create a backup.

The following are an exemplary list of types of features that make it easier to create CC instances, to manipulate the CC instances, to move them, and to add files and folders to the CC instances. These capabilities are designed/configured so as to ensure that encrypted files remain encrypted (e.g., when moved, split, and so on), that passwords are correctly moved, and that all operations are easy and intuitive to use and implemented in all CC platforms. These features includes: (a) merge, split, move, and copy CC instances; (b) cut, copy, and paste files and folders of files from one CC instance into another (e.g., as an enabler for features such as backing up CC instances); (c) move selected files and/or folders (but not all) from or between CC instances; (d) the ability to select where the CC data file is to be placed within a cloud storage platform's folders (e.g., possibly as part of an installation or administrative/management routine that would be used to create the initial CC executable and data file within a cloud storage platform's folders); and (e) while some embodiments of the encryption method involves the product (exe and data file) being copied by a user from and to cloud storage folders, a feature/function/utility may be provided that allows for creation (e.g., by selecting a directory) and moving (installing) the appropriate CC files into the directory (or by pre-installing the CC unit into a folder depending on the scenario such as pre-installing on a personal cloud storage device by the device manufacturer or distributer).

It is envisioned by the inventor that the CC program will be designed for working in Windows Explorer or any file, directory, and/or hierarchical user interface for viewing, navigating, and manipulating files. As an example, the CC program may include a GUI generator that provides GUIs with right click menu options (and/or other Windows Explorer-type interfaces which support extension by third party products) to the Windows Explorer that would directly invoke CC program functions. Examples may include: (a) the ability to create a new CC instance using a right click mouse menu item on a Windows Folder/Directory; and (b) the ability to select a file (e.g., CTRL-C) and have it moved to CC via paste (e.g., CTRL-V) onto a selected (e.g., via a mouse) CC instance. If the CC instance does not exist and a paste (CTRL-V) is done in a folder, a CC instance may be created in the directory and then the file can be moved. These examples of features are specific for the operation of a Windows-based client device that uses or has Windows Explorer, but it is believed that these features would also benefit other platforms with an Explorer-like browser/interface. Further, Cloud Crypter is not limited to Windows Explorer-type interfaces and may be used with other browsers, devices, and/or operating systems such as those provided by Apple Inc., Google Inc., and the like.

The CC program and encryption methods may be designed and configured to facilitate adding and/or synchronizing files. In this regard, the following features/functions may be provided to make it easier to add files to a CC instance: (a) the ability to have files dropped into a specific cloud folder automatically moved into a CC instance without a user needing to explicitly add files from the application; (b) the ability to establish a local file or folder on the computing device which upon changes to the file is automatically moved to a previously established CC instance and saved in the CC instance (and encrypted if it is established that it is to be encrypted); (c) synchronization feature that keeps track of the source file that is moved into a CC instance and subsequently tracks changes in the source file; and (d) synchronizing and moving files between CC instances.

With regard to user interfaces or the CC program GUI, other features are included that support user interfaces that are familiar and easy for users, that make sense for the product, and that are relevant for the particular cloud storage platform, such as: (a) a web interface along with the current standalone desktop interface (note that many cloud storage platforms provide web user interfaces for access to stored files as well as one that operate on the client device/platform such that this feature may be similar in that it would allow the CC functions but via a web browser interface (further, this feature may allow a user to access a CC folder over a network such as the Internet)); (b) provide a Windows Explorer File Manager user interface for working with CC folders, which would be similar to the desktop Windows interfaces provided by some cloud storage providers that display files and folders in the Windows Explorer interface (e.g., the interface that is familiar to people working with files on Windows-based computers) such that the CC program GUI could work as explained above but a Windows Explorer user interface would be able to access the CC data file and format files and folders in a Windows Explorer view; (c) a file/folder/directory display interface that is native/local/specific for the type of device (e.g., a mobile device may have a different metaphor or way of describing the displaying of collections of files); or (d) create a single viewer file folder window for all CC instances used/stored by a user across multiple cloud storage platforms. With this final feature, users can use a CC unit or instance in a single folder or multiple folders in any of the cloud directories they are able to access. This feature would provide a user interface for viewing all of the CC instances in a single user interface versus having to open the application for each instance.

With regard to import functionality, it may be desirable for the CC program and encryption method to be implemented to make it easier for files to be input to a CC instance. This is especially true when doing in bulk importing from a single location such as a zip file, other cloud storage encryption storage, USB devices, and the like. In the case of zip files (or other similar types of files), importing may be configured to take the files from the original format and pulling them into the CC instance to gain access to the features of the CC program. Types of import functions that may be included are: (a) import zip files into a CC instance; (b) import from other cloud storage encryption products into a CC instance; (c) import an entire directory; and (d) import from connected or wirelessly accessible storage such as a USB or similar device.

With regard to collaboration and sharing, the encryption method may be designed in some cases to provide shareable links (e.g., URLs) to individual CC files for access by web applications or for inclusions in e-mails. This may involve creating a URL to a file stored within a CC instance that when accessed causes the file to be unencrypted and then accessed/displayed in a web page. Cloud storage providers provide functionality that creates shareable links to files they store in their cloud storage system. These links may be placed into a browser or used to access the files individually. The links can be e-mailed to other users. If the files are not encrypted, there is an exposure if the files are accessed by a user whose credentials have been hacked. Using CC resolves this situation by creating links to the files within a CC instance that will require an additional password to obtain the unencrypted version of the file. This person still will not be able to view the files that are actually stored in the CC instance without the CC encrypt/decrypt password for that file. This solution may require the ability for software to access files and folders stored in a CC instance externally versus from within the CC application.

E-mail features may be included to facilitate collaboration and/or sharing of the CC-protected data. First, it may be useful for the CC program and method to be designed to allow/enable sending e-mails with attachments that are one or more files stored in a CC instance. For example, this may involve e-mailing files that are encrypted and prompting a user who receives the e-mail with these encrypted files attached for the password prior to opening them or, alternatively, allowing the user who sends the e-mail to specify the password and sending the files unencrypted. Second, it may be useful to automatically save attachments received in e-mails into a CC instance (similar to the way a folder is designated for storing files downloaded by a browser) and/or the ability to select a CC instance as the destination for saving an e-mail attachment. It is also possible that users will send an entire CC instance in an e-mail to another user.

With regard to data content, it may be desirable to configure the CC program and encryption method to use CC instances to hold content such as digital music, videos, or other media, such as document content, and such as files, which can then be stored in the cloud and sold or distributed via links to the CC instance. As an example, a content provider could store legal documents in a CC instance in a cloud storage folder. All of the documents would be encrypted in the CC instance. To share this content, the cloud storage folder would be shared with other users of the cloud storage platform and then those users would gain access when they are provided with the password. This has an effect of sharing encrypted content where the content is pre-packaged. Such a process can easily be implemented for distributing or “sharing” music, video, and other forms of digital content.

Further, with regard to content, the CC program/environment may be used as a packaging format for product installations. This may involve packaging all files required to install a software product in a CC instance. In other cases, CC instances may be enabled to play media files within the CC software so it becomes a means for storing the files, encrypting them, and also playing them (without ever leaving the product). Still further, CC instances/environments may be enabled to display, edit, and the like the files stored and encrypted in a CC instance so that users never exit CC units/instances in order to work with files that it stores on the cloud. As an example, a CC instance that has a stored PowerPoint file or the like can be configured to allow the PowerPoint file or the like to be displayed in a CC window or GUI where it can be shown and/or edited.

The CC program includes an encryption tool that may be chosen to provide banking-level security such as choosing an algorithm to provide FIPS 197-certified 128 or 256-bit AES encryption. In other cases, PKI-type support may be chosen in some cloud storage scenarios. In some preferred embodiments, the cryptography or encryption algorithm is an implementation of the Advanced Encryption Standard (AES). The AES is a block cipher that has been adopted as an encryption standard by the U.S. government and is used worldwide. When using the AES for the encryption algorithm or tool, block sizes of 128 or 256 bits can be used during encryption to provide a key that typically has a key size of 128 bits (but 192-bit keys may be used). Operation of the AES is not described in detail herein as it has been analyzed extensively and is well-known by those skilled in the art and has proven acceptable for blocking attacks or attempts to decipher data encrypted according to the AES with key lengths or sizes over 128 bits, which provides very strong security. The encryption algorithm or tool takes a password of eight or more characters and creates a random key. The key is a piece of information that controls operation of the cryptography/encryption algorithm or tool. Generally, in encryption, a key specifies the particular transformation of plaintext into ciphertext or vice versa during decryption. For the AES, enciphering the same plaintext but with a different key produces totally different ciphertext stored in an encrypted file (e.g., a password that creates a key is required to decipher the encrypted file properly). The cryptography/encryption algorithm can be described as a symmetric key algorithm as the same key is used for both encryption and decryption.

Compression of data may also be provided by the CC program. For example, compression may be provided to reduce the size of the CC data file by adding support for compressing files and folders stored in a CC data file. With regard to encryption and data administration, the CC or encryption method may include retention of a change history/version history that can be used for audit (or other purposes) for tracking activities related to a CC instance such as to changes to files and folders of files. This is the type of feature that may be desired for usage in industries with compliance regulations. It is also a useful feature for enabling users to revert back to prior versions of files. This may involve retaining previous versions of files if they are updated in the CC instance. It may also involve providing options regarding how many versions should be retained, how long versions should be retained, and so on.

Data administration may also include making “Lock” an option that can be set so that it always occurs or occurs automatically for all files stored in a folder. This may include the ability to use the instance password (i.e., the password the user is required to enter when the application is first started) for encryption of files and folders as a default. When an option is set to indicate that the instance password should be used, all files and folders added can be automatically encrypted with this password. Then, when a user chooses to add a password for a specific file or folder, this will replace the instance password.

With regard to user security, the CC instance may require a password to enter the application. Many other applications require both a user ID and a password, and such an implementation or option may be provided with CC programs. In addition, some features such as notifications and auditing can be supported by use of requiring input of a user ID per user accessing the CC instance. In concert with the user ID and password combination per user, it may be useful to provide the ability to support single sign on technology that allows access to CC instances with a user ID and password from a different system or application (e.g., via a standards-based technology such as Oauth, SAML, or the like). Some implementations may provide LDAP integration for enhanced user security. Further, two-step verification may be included to provide an extra layer of security at login. The CC program may also be designed to allow a user to choose to receive security codes by text message or via any time-based one-time password (TOTP) application.

With regard to administrative interfaces (e.g., for enterprise usage of the CC instances), it may be useful to provide features that would support use within an enterprise. Usage and deployment abilities in the enterprise setting can be more rigorous and less flexible than for end users and consumers. Hence, it may be desirable to implement: (a) user/password management; (b) file/folder password management; (c) monitoring/auditing; and (d) file/folder settings (e.g., allow administrators to designate cloud services/folders that users can use to store CC instances and/or be sources of files or set up as automatic sources for CC storage (e.g., anything added to a specified folder is encrypted and stored into a specific CC archive)).

Some implementations of the CC program and encryption methods provide the ability to obtain or reset file and folder passwords. The same or other implementations may be configured to provide notifications and alerts that can be sent to the person (or others) who created the CC instance when files change, are updated, are downloaded, are encrypted, and so on. Notifications and alerts can be monitored to inform a person that something new has been added to a shared CC instance. A notification can also signify a security breach when a user is notified that someone unknown who has not been invited to share or open the instance attempts to open and access files/folders. Programmatic interfaces can be provided that enable third parties to integrate, use, access, and/or add CC functionality. For example, SDKs can be used to make it easy to add partners and extend the features of CC programs and encryption methods to third parties.

The above description generally describes and refers to Cloud Crypter (or CC program) as an “encryption program.” In practice, though, it should be understood that Cloud Crypter is a software program that uses and performs encryption of files and folders, and Cloud Crypter can, hence, be considered to be a program that provides data security to files and folders stored in the cloud using encryption. With this in mind, this description and the supporting figures are directed to a software program that is described as (or something like) a cloud storage data security manager that may be installed in a cloud storage provider folder. The cloud storage data security manager is typically a standalone software program that is designed to be utilized with any cloud storage provider e.g., Dropbox, Box.net, Google Drive, or the like. The cloud storage data security manager provides users with security for the data they store in the cloud on cloud storage provider platforms. One exemplary (but not limiting) primary use is to maintain the security of files it stores using encryption processes and algorithms. Note that in this disclosure Cloud Crypter is an example of a cloud storage data security manager.

In this description and following claims, executables can be compiled code and/or interpreted code, irrespective of programming language or type of execution engine/runtime that a client device supports. Any of these executables may be described as or include .exe files. Also, examples are provided of data files that are .dat files. It should be understood that the present methods and technologies may be used with nearly any file that is used to store data (e.g., to hold or maintain encrypted data and the like).

In the description, cloud storage folders are described as being used and processed as part of implementing the CC technology. These are the folders stored on/in cloud storage platform servers created by users to store data. The folders and files managed by the cloud storage platform providers are stored locally on the client and also remotely in the cloud storage servers. From the perspective of this description and the claims, this pairing of folders may be considered as the same thing (as “cloud storage folders”), typically without concern whether the folders are on separate platforms. The described CC technology and methods deal with storing Cloud Crypter units into cloud storage folders.

In practice, some of the cloud storage platforms allow remote-only storage of a user's files/folders, which use little-to-no local file/folder storage. In this case, the files can only be accessed when the device is connected to a network or the internet. When a user views or accesses the cloud storage folder or files via UI on the client device, it shows the remotely stored files and folders (e.g., similar to what one sees when you use the cloud storage provider's web user interfaces). If a user edits the files (e.g., a Word document stored in cloud storage folder or other stored document or data file), some type of local copy is needed, but it could be only in memory or in temp directory. In this case, a synchronize step may not occur between local and remote cloud storage folders and a CC file would (or may) not be stored locally. This use case may be similar to what happens when a CC instance (unit) is stored on a personal cloud device (e.g., such as the devices or systems available from Western Digital or similar producers/distributors).

The activating function for the CC technology, which launches the CC program, may be performed differently on different computing platforms. As an example, when using CC on a tablet the first time, it may be necessary to download a CC program, which in this case may be a mobile/tablet app or mobile/tablet execution unit supported by the particular device's operating system provider from an app store. This may happen when the user accesses the CC unit in the cloud storage folder or possibly before they are able to access the cloud storage folder. Another similar or related example is utilizing CC technology using a personal storage device (e.g., as the cloud storage platform) where the operating system on that device may be Linux, a custom OS for the device, or other OS. Users accessing the personal cloud device may do so from tablets, PCs, devices implementing an Apple-based OS, or the like, and the CC program is configured to operate and to be launched correctly on each of these platforms.

With use of the CC technology, encryption generally happens as the users are working with the encryption program and whenever the data file portion of the instance is stored. Further, it typically is the encryption program's (the Cloud Crypter program's) executable code that stores or causes the CC data file to be stored. At some point, this storing operation causes the cloud storage provider's executable code to be invoked. It is in some embodiments the cloud storage provider's executable code that performs the actual storing of the CC data file into the cloud storage folder (which may or may not be local). If the cloud storage provider is using local folders to store data then at some point it will perform synchronization that causes the CC data file to be stored (by the cloud storage provider) remotely.

While this disclosure contains many specifics, these should not be construed as limitations on the scope of the disclosure or of what may be claimed, but rather as descriptions of features specific to particular embodiments of the disclosure. Furthermore, certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products. The above described embodiments including the preferred embodiment and the best mode of the invention known to the inventor at the time of filing are given by illustrative examples only.

1. A system for providing cloud storage of digital data, comprising:
a cloud storage provider system including at least one server storing a cloud data folder with data associated with a data storage user;
a client device operable to communicate over a digital communications network with the cloud storage provider system to access the cloud data folder on the at least one server; and
an encryption unit comprising an executable encryption program and a data file, wherein the encryption unit is provided in the cloud data folder, wherein the data file of the encryption unit includes a subset of the data associated with the data storage user, and wherein the executable encryption program includes an encryption tool encrypting the data file prior to storing the data file in memory on the client device and prior to storing the data file in the cloud data folder in the at least one server of the cloud storage provider system.

2. The system of claim 1, wherein the encryption tool comprises a 128 or 256-bit AES encryption algorithm.

3. The system of claim 2, wherein the encryption tool performs the encrypting of the data file using one or more passwords provided by the data storage user via operation of the client device and associated with one or more subsets of the data file.

4. The system of claim 3, wherein the one or more subsets of the data file are identified by the data storage user by selection of portions of the data in the cloud data folder presently outside the encryption unit or selection of data stored in memory of the client device or memory accessible by the client device.

5. The system of claim 1, wherein, after the storage of the data file, the executable encryption program generates a user interface on a display device of the client device prompting entry of an encryption instance password assigned to the executable encryption program and, only when a user-provided password is received matching the encryption instance password, providing access to the encrypted data file in the cloud data folder.

6. The system of claim 1, wherein, after the storage of the data file, the executable encryption program generates a user interface on a display device of the client device first prompting user selection of a portion of the encrypted data file to access, second prompting user entry of a password associated with the portion of the encrypted data file, and, in response to receipt of a user-entered password, using the encryption tool to decrypt the encrypted data file, when the user-entered password matches the password associated with the portion of the encrypted data file, using the user-entered password.

7. The system of claim 6, wherein the portion of the encrypted data file is a folder including a plurality of files.

8. The system of claim 6, wherein the portion of the encrypted data file is a single file of data and wherein a different password is assignable by an operator of the client device to each file of data in the encrypted data file.

9. A method of providing data security when using cloud storage, comprising:
with a client device, accessing via a network a cloud storage folder on a data storage device in a cloud storage system;
in the cloud storage folder, loading a data security folder comprising an encryption program executable and a data file;
inserting a set of user data into the data file;
assigning a password to the set of user data;
executing the encryption program executable to encrypt the set of user data with an encryption algorithm using the password; and
after the executing step, storing the cloud storage folder in memory of the client device or on the data storage device of the cloud storage system,

10. The method of claim 9, wherein the password is assigned to the set of user data based on user input via a user interface on the client device.

11. The method of claim 9, wherein the set of user data comprises a file or a folder of files.

12. The method of claim 9, wherein the encryption algorithm comprises a 128 or 256-bit AES encryption algorithm.

13. The method of claim 9, further comprising, after the storing step, second accessing the cloud storage folder with the client device or another client device, activating the encryption program executable, and only when the password is received using the encryption algorithm to decrypt the encrypted set of user data.

14. The method of claim 9, further comprising generating a link to the data security folder in the cloud storage folder in the cloud storage system and operating the client device to communicate the link to an additional client device, wherein the additional client device is operable to select the communicated link to access the data security folder.

15. The method of claim 9, further comprising operating the client device to generate and transmit an e-mail over the network to an additional client device, wherein the e-mail includes all or a portion of the encrypted set of user data.

16. An encryption method for cloud storage systems, comprising:
receiving a request to open an encrypted file in a cloud storage folder;
prompting the user to input a password associated with the encrypted file;
determining the password is valid; and
only when the password is determined valid, decrypting the encrypted file using the password, wherein the decrypting of the encrypted file is performed by an encryption program associated with the encrypted file in the cloud storage folder.

17. The method of claim 16, further comprising, prior to the receiving of the request, encrypting an unecrypted data file selected via user input on a client device with an encryption algorithm using a password matching the password that is determined to be valid.

18. The method of claim 16, wherein the encrypted file is decrypted using a 128 or 256-bit AES encryption algorithm.

19. The method of claim 16, further comprising, prior to the receiving of the request, storing an executable version of the encryption program and a data file including the encrypted file in a folder within the cloud storage folder.

20. The method of claim 16, wherein the decrypting is performed on a client device in communication with a cloud storage system storing the cloud storage folder and further comprising, after the decrypting, running the encryption program on the client device to encrypt the decrypted file to create a secondly encrypted file and storing the secondly encrypted file in local memory of the client device prior to synchronizing of the cloud storage folder with the cloud storage system.
